(19) United States
(12) Patent Application Publication
(10) Pub. No.: US 2020/0355578 A1
(43) Pub. Date: Nov. 12, 2020

(54) TISSUE CHIP CORE-MAKING SYSTEM BASED ON IMAGE RECOGNITION AND POSITIONING AND CORE-MAKING METHOD THEREOF

(71) Applicant: THE THIRD XIANGYA HOSPITAL OF CENTRAL SOUTH UNIVERSITY, Changsha (CN)

(72) Inventors: Bo LIU, Changsha (CN); Zhen WANG, Changsha (CN); Kehua GUO, Changsha (CN); Jian KANG, Changsha (CN); Xiangzhi SONG, Changsha (CN); Zhepeng XIAO, Changsha (CN); Zhuoyu LI, Changsha (CN); Kexin LONG, Changsha (CN); Lihua HUANG, Changsha (CN); Yichen GUO, Changsha (CN); Chaoyang SHEN, Changsha (CN)

(73) Assignee: THE THIRD XIANGYA HOSPITAL OF CENTRAL SOUTH UNIVERSITY, Changsha (CN)

(21) Appl. No.: 16/966,024

(22) PCT Filed: Jun. 13, 2018
(86) PCT No.: PCT/CN2018/090922

§ 371 Date: Jul. 30, 2020

(30) Foreign Application Priority Data
Jun. 5, 2018 (CN) 201810570593.3
Jun. 5, 2018 (CN) 201820862772.X

(51) Int. Cl. G01N 1/08; G01N 1/28; G06K 9/78; G06T 7/73; G06K 9/62

(52) U.S. Cl. CPC G01N 1/08; G01N 1/286; G06K 9/78; G06T 7/73; G06K 2209/05; G01N 2001/2873; G06T 2207/30024; G06T 2207/30072; G06K 9/6255

(57) ABSTRACT

A tissue chip core-making system based on image recognition and positioning and a core-making method thereof—includes a cutting system and a computer control system. The cutting system includes a numerical control cutting machine, XYZ-axis translation worktables, a 360° rotation turntable, a recipient wax block rack, a freezing table and an image recognition and positioning module. A core-making process based on the core-making system includes: lofting, sample position recognition, tissue sample image acquisition, tissue sample image processing, cutting parameter setting, tissue sample cutting, tissue core information recognition and storage to obtain a tissue core with information traceability. The method obtains a coring region through visual recognition, and has the characteristics of high automation degree and high work efficiency.

### CROSS-REFERENCE TO THE RELATED APPLICATIONS

This application is the national stage entry of International Application No. PCT/CN2018/090922, filed on Jun. 13, 2018, which is based upon and claims priority to Chinese Patent Application No. 201810570593.3, filed on Jun. 5, 2018, and Chinese Patent Application No. 201820862772.X, filed on Jun. 5, 2018, the entire contents of which are incorporated herein by reference.

### TECHNICAL FIELD

The present invention relates to a core-making system and a core-making method, in particular to a tissue chip core-making system through image recognition and positioning and a core-making method using the core-making system, and belongs to the technical field of biological and medical instruments.

### BACKGROUND

Tissue arrays, also called tissue microarrays (TMAS), means that a plurality of different tissue samples are put on a single recipient block or paraffin block. The recipient block is sliced by a microtome according to a general method to obtain a specimen.

The tissue microarray technique is an important innovation in experimental techniques. Clinical pathologists and biologists use slices of arrayed biological tissues and pathological specimens for high-throughput analysis to obtain key information of states and changes of biological tissues and pathological specimens.

In a tissue array production process, a hollow sampling needle needs to he used to prepare tissue cores from various kinds of tissues or sample blocks through punching. After the tissue cores are trimmed one by one, the tissue cores are put in a recipient block according to a preset sequence. In the preparation of tissue arrays of multiple samples, the repeated operations such as sampling and tissue core trimming are time- and labor-consuming. Tissue chip preparation systems and methods commonly used in the market have the following problems. Firstly, in an existing tissue chip preparation process, a sampling needle is used for sampling. For example, in Chinese Utility Model Application No. 201620069234.6 with a granted publication No. CN205317515U, a sampling needle performs sampling in a pressing and annularly rotating mode. Although the influence on the donor tissue block or wax block is small, the integrity of the sampled tissue core cannot be ensured, and serious problems such as tissue compression, deformation, and fracture occur in the prepared wax core. Additionally, the sampling depth of the sampling needle is not easy to control. Although an existing mechanical sampling device can precisely control the puncture depth, the front end of the wax core may be a blank wax core in the case of sampling a thin sample. As a result, tissue cores in the prepared tissue chip are not in the same plane, vacant sites appear in the sliced chip array, reducing the chip preparation efficiency and the yield rate. Secondly, for example, in the typography type tissue chip preparation instrument and method used in Chinese Patent Application No. 201310396643.8 with a published application No. CN103439163A, the process of putting a wax core into a wax mold requires manual operations, which is not fully automated and cannot ensure the precision. In addition, the wax core addressing result in the invention needs to be manually coded and recorded, which is inefficient and cannot ensure the accuracy. Thirdly, although a few automatic tissue chip preparation instruments with image recognition are available, all of them are developed for needle-type sampling machines. The single two-dimensional image recognition monitoring system built therein cannot completely control wire-cut coring, a sampling region can only be selected from the upper part of the wax block, and the sampling depth cannot be selected from the side of the wax block, which is likely to lead to blank wax cores, failing to achieve high automation while ensuring the coring quality.

### SUMMARY

To solve the defects in the existing tissue array preparation techniques, an objective of the present invention is to provide a tissue chip core-making system based on image recognition and positioning. The core-making system features a high degree of automation, precise and high-speed visual recognition and positioning, little damage to sample tissues, high coring efficiency and high yield rate. In addition, a database can be built for managing information of prepared tissue cores, thereby improving completeness and traceability of information of tissue cores.

Another objective of the present invention is to provide a core-making method of the core-making system. The method features high core-making efficiency and high yield rate, and is especially suitable for the preparation of tissue arrays of multiple samples.

To achieve the above objectives, the present invention provides a tissue chip core-making system based on image recognition and positioning, comprising:

a cutting system and a computer control system, wherein

the cutting system comprises a numerical control cutting machine, XYZ-axis translation worktables, a 360° rotation turntable, a freezing table, a recipient wax block rack and an image recognition and positioning module;

the numerical control cutting machine comprises a cutting machine worktable and a cutter, the XYZ-axis translation worktables are disposed on the cutting machine worktable, the recipient wax block rack is disposed on the XYZ-axis translation worktables, the 360° rotation turntable is disposed on the XYZ-axis translation worktables, the freezing table is disposed on the 360° rotation turntable, the recipient wax block rack is disposed on the freezing table, and the cutter is disposed above the freezing table; and

the image recognition and positioning module comprises a linear array CCDa and a linear array CCDb, the linear array CCDa is disposed above the freezing table, and is configured to recognize and acquire patterns of an X-Y plane, the linear array CCDb is disposed at a lateral part of the 360° rotation turntable, and is configured to recognize and acquire patterns in a Z-axis direction, and the linear array CCDa and the linear array CCDb are both connected with the computer control system.

In a preferred solution, the numerical control cutting machine is a numerical control diamond wire cutting machine or a numerical control optical fiber laser cutting machine. The numerical control cutting machine is configured to cut a sample tissue of a recipient wax block to obtain a wax core. Preferably, the numerical control cutting machine is a numerical control diamond wire cutting machine. Selecting a suitable numerical control cutting machine can reduce the damage to the sample tissue and provide high-speed and precise cutting, and facilitate the cutting of the sample tissue of the recipient wax block.

In a preferred solution, the XYZ-axis translation worktables are sequentially an X-axis translation worktable, a Y-axis translation worktable and a Z-axis translation worktable from top to bottom. The XYZ-axis translation worktables can control the recipient wax block rack for putting the sample of the recipient wax block to move freely in a three-dimensional space.

In a more preferred solution, an X-axis sliding device is disposed between the X-axis translation worktable and the Y-axis translation worktable. The X-axis sliding device mainly controls the recipient wax block rack for putting the sample recipient wax block to translate in an X-axis direction.

In a more preferred solution, a Y-axis sliding device is disposed between the Y-axis translation worktable and the Z-axis translation worktable. The Y-axis sliding device mainly controls the recipient wax block rack for putting the sample of the recipient wax block to translate in a Y-axis direction.

In a more preferred solution, an ascending and descending stud is disposed at the lower part of the Z-axis translation worktable. The ascending and descending stud mainly controls the recipient wax block rack for putting the sample of the recipient wax block to translate in a Z-axis direction.

In a more preferred solution, an X-axis stepping motor is disposed at a side surface of the X-axis translation worktable, a Y-axis stepping motor is disposed at a side surface of the Y-axis translation worktable, and a Z-axis stepping motor is disposed at the bottom of the Z-axis translation worktable. The X-axis stepping motor is connected to the X-axis translation worktable through a screw. The screw is driven to rotate by the X-axis stepping motor to drive the X-axis translation worktable to translate along an X axis. The Y-axis stepping motor is connected to the Y-axis translation worktable through a screw. The screw is driven to rotate by the Y-axis stepping motor to drive the Y-axis translation worktable to translate along a Y axis. The ascending and descending stud is driven to rotate by the Z-axis stepping motor to drive the Z-axis translation worktable to translate along a Z axis.

In a more preferred solution, the X-axis stepping motor and the Y-axis stepping motor respectively control the X-axis sliding device and the Y-axis sliding device to drive the X-axis translation worktable and the Y-axis translation worktable to translate at any angles in the X-Y plane

In a more preferred solution, the Z-axis stepping motor drives the Z-axis translation worktable to move upward and downward in the Z-axis direction by controlling the ascending and descending stud.

In a more preferred solution, travel ranges of the X axis, the Y axis and the Z axis are all from −100 mm to 100 mm. The entire XYZ-axis translation worktables can control the recipient wax block rack for putting the sample to move freely in a cubic three-dimensional space with a side length of 200 mm.

In a further preferred solution, the X-axis sliding device or the Y-axis sliding device is a set combination of a sliding table, a guide rail and a ball screw. The ball screw is disposed between the sliding table and the guide rail, transforming sliding of the bearing of the sliding table and the guide rail into rolling, so that the relative movement distance between the sliding table and the guide rail can be precisely controlled.

In a further preferred solution, the sliding table of the X-axis sliding device is disposed at the bottom of the X-axis translation worktable, the guide rail of the X-axis sliding device is disposed on the top of the Y-axis translation worktable, and the ball screw is disposed between the sliding table and the guide rail of the X-axis sliding device.

In a further preferred solution, the sliding table of the Y-axis sliding device is disposed at the bottom of the Z-axis translation worktable, the guide rail of the Y-axis sliding device is disposed on the top of the Z-axis translation worktable, and the ball screw is disposed between the sliding table and the guide rail of the Y-axis sliding device.

In a further preferred solution, grating rulers and encoders are respectively disposed on the sliding tables of the X-axis translation worktable and the Y-axis translation worktable. The computer control system can precisely position the movement of the XYZ-axis translation worktables through the grating rulers and the encoders.

In a further preferred solution, a grating ruler and an encoder are disposed on the ascending and descending stud of the Z-axis translation worktable.

In a preferred solution, the freezing table is of a round plate-shaped structure, a radius size is the same as a radius size of a cross section of the 360° rotation turntable, and the freezing table is fixed onto the 360° rotation turntable through screws.

In a preferred solution, the 360° rotation turntable is a cylindrical structure comprising an upper rotation turntable and a lower rotation turntable, the lower rotation turntable is fixed on the XYZ-axis translation worktables, the upper rotation turntable and the lower rotation turntable are movably connected, and the upper rotation turntable can rotate freely within a 360° angle relative to the lower rotation turntable. The configuration of the 360° rotation turntable realizes the movement of the recipient wax block rack about an axis, providing a basis foundation for cutting wax cores with different shapes and different sizes.

In a more preferred solution, the 360° rotation turntable is respectively provided with angle scales on side walls of the upper rotation turntable and the lower rotation turntable, an operating handle for controlling the rotation and fixation of the upper rotation turntable is disposed on the side wall of the upper rotation turntable, and the lower rotation turntable is fixed on the XYZ-axis translation worktables through screws. Through the operating handle, the upper rotation turntable can be manually operated to rotate relative to the lower rotation turntable, to coarsely adjust the position of the sample tissue put on the 360° rotation turntable. The lower rotation turntable is fixed through a screw, and can be easily detached.

In a preferred solution, feature images for the image recognition and positioning module to recognize and position are respectively disposed at each of four corners of an outer frame of the recipient wax block rack for putting a recipient wax block. The image recognition and positioning module recognizes the recipient wax block mainly according to different feature images disposed at the four corners of the outer frame of the recipient wax block rack. The feature images are any images suitable for recognition.

In a preferred solution, the computer control system controls the movement of the XYZ-axis translation worktables, controls the image recognition and positioning module to perform information acquisition and processing, and controls the cutting position checking of the numerical control cutting machine.

In a preferred solution, the computer control system is connected with each alternating current servo motor and grating ruler of the XYZ-axis translation worktables through a three-axis linkage control card.

In a preferred solution, the computer control system is connected with the image recognition and positioning module through a Matrox Solis ECL/XCL-B image acquisition card.

The present invention further provides a core-making method based on the tissue chip core-making system, comprising the following steps:

1) fixing a recipient wax block on a recipient wax block rack, driving XYZ-axis translation worktables to move by using a computer control system until feature images on the recipient wax block rack are recognized by an image recognition and positioning module, and at the same time, storing a position of the feature images as an original point by a computer;

2) performing image acquisition and information processing on the recipient wax block through the image recognition and positioning module to obtain a three-dimensional image of the recipient wax block;

3) processing the three-dimensional image of the recipient wax block, and after a sample tissue region and a thickness of sample tissues in the recipient wax block are obtained, setting a region available for core-making; and

4) controlling a numerical control cutting machine through the computer control system to perform cutting calibration, then, setting cutting parameters, and cutting the recipient wax block to obtain a wax core.

In a preferred solution, the obtained wax core is subjected to visual recognition to obtain a feature value, a database is built, and feature value information of the tissue core and other information of the sample tissues are stored for subsequent use and query.

In a preferred solution, a cutter of the numerical control diamond wire cutting machine is connected to the computer control system, and the operation of the cutter is precisely controlled through the computer control system.

In a preferred solution, the upper rotation turntable and the lower rotation turntable of the 360° rotation turntable are movably connected by connecting members, which are, for example, a cylinder and a cylinder sleeve seamlessly fitted to each other. The cylinder and the cylinder sleeve are mounted at the center of a bottom portion of the upper rotation turntable and the center of a top portion of the lower rotation turntable respectively.

The CCD module in the present invention includes a linear array CCDa and a linear array CCDb and is configured to acquire and save three-dimensional data of samples at high speed.

A plurality of recipient wax blocks can be put on the recipient wax block rack in the present invention.

The core-making method of the tissue ship core-making system based on the CCD positioning of the present invention includes the following steps:

Step 1, control software of the core-making system is opened, a LOFT button is clicked, and a recipient wax block that has been numbered and pre-frozen is put on a recipient wax block rack;

Step 2, a point position button is clicked, and XYZ-axis translation worktables start to move until feature images of an outer frame of the recipient wax block rack for putting the recipient wax block, fixed on the XYZ-axis translation worktables, are successfully recognized respectively; at the same time, coordinates information of each of the feature images is stored by a computer automatically;

Step 3, images of the recipient wax block are acquired by a linear array image recognizer a and a linear array image recognizer b, and a three-dimensional image of the recipient wax block is obtained by processing images acquired by an image recognition and positioning module through a specific algorithm;

Step 4, the three-dimensional image acquired by the image recognizer is processed to obtain a sample tissue region and a thickness of the sample tissues in the recipient wax block, and a region available for core-making in the region is set;

Step 5, a numerical control cutting machine is controlled to perform cutting calibration, reasonable cutting parameters are set;

Step 6, cutting is performed, where the recipient wax block is cut by the cutting machine according to a preset track to obtain a tissue core.

Step 7, the obtained tissue core is visually recognized to obtain a feature value, and a database is built to store feature value information of the tissue core and other information of tissue samples for subsequent use and query.

In the tissue chip core-making system of the present invention, the 360° rotation turntable is disposed on the XYZ-axis translation worktables, so that the recipient wax block rack can rotate about an axis, providing a basis for cutting wax cores with different shapes and sizes. One or more different recipient wax blocks can be disposed on the recipient wax block rack, providing a basis for mass preparation of tissue cores. The images of the recipient wax blocks are recognized by using the image recognition and positioning module; by processing the grayscale of the images, boundary features of the sample tissues are automatically extracted, and the sample tissue region is automatically divided into core-making regions according to the quantity and the cross-sectional size of the required tissue cores. Image acquisition and analysis are realized through the computer control system, reducing errors and manpower of manual operations dramatically. The sample tissues are cut by using the numerical control wire-cutting machine, reducing the damage to the sample tissues effectively, and improving the yield rate of the tissue cores; the wire-cutting machine can cut one or more recipient wax blocks at a time, thus the efficiency of core-making is improved dramatically. After the core-making is finished, the feature values of the prepared tissue cores are obtained through visual recognition, and a database is built to store the feature values of the tissue cores and other information, to facilitate subsequent query and use.

The control principle of the tissue chip core-making system of the present invention is as follows: First, a donor wax block rack is moved out of the housing through a Y-axis sliding table, and after the donor wax block is fixed, the donor wax block rack is moved back into the housing through the Y-axis sliding table. In this case, a linear array image recognizer a starts to work. Through the movement of the donor wax block rack on an X-axis sliding table and the Y-axis sliding table, the linear array image recognizer a acquires feature images on the donor wax block rack above the wax block to determine a relative position of each of the recipient wax block, provides coordinates information and stores the coordinates information automatically. Then, the image recognizer a is moved in the X-Y plane through the donor wax block rack to acquire images on the donor wax block, and a histogram threshold segmentation algorithm is used to segment the graying summary images, as shown by Equation (1) below. The graying summary images are relatively simple, with a histogram clearly showing two peaks, and a relatively good segmentation effect can be realized by using a grayscale average as a segmentation threshold. Driven by a Z-axis alternating current servo electric motor, the X-Y worktable moves upwards, so that the donor wax block enters a work region of a cutting module. In this case, the donor wax block rack also moves to a side of a linear array image recognizer b, and the threshold segmentation algorithm is also suitable for segmenting the graying summary images to determine a depth of the sampling. After relative position parameters of the cutting are determined, through a three-axis linkage control card, a computer controls upward and downward movements of the XYZ-axis translation worktables and forward, backward, leftward and rightward movements of the donor wax block rack, to finish coring and cutting on the wire-cutting worktable. After the cutting, the obtained tissue cores are visually recognized one by one to obtain feature information of each of the tissue cores, and a database is built to store the feature information of the tissue cores and other information.

$$f ( i , j ) = \{ \begin{matrix}255 , & f ( i , j ) \geq T \\ 0 , & f ( i , j ) < T\end{matrix}$$

(i is a horizontal vector, j is a vertical vector) Equation (1).

Compared with the prior art, beneficial effects brought by the technical solutions of the present invention are as follows: The core-making system of the present invention uses the wire-cutting core-making technology based on CCD three-dimensional positioning to replace the traditional sampling needle core-making technology, and through the visual recognition of the core-making region and the core-making depth, has advantages of high positioning precision and small error. The tissue cores are obtained by cutting the recipient block using the numerical control wire-cutting machine, and when the numerical control wire-cutting machine is used for the core-making, the core-making position is selected through the linear array CCDa, and the core-making depth is selected through the linear array CCDb. Finally, the wire traveling track of the numerical control wire-cutting machine is controlled to overlap with the coring region through programming, enabling the core-making system to have the features of high processing precision and efficiency and small damage to samples, improving the core-making efficiency and the yield rate effectively. The database is built for managing the information of prepared tissue cores, improving the completeness and traceability of information of tissue cores.

### BRIEF DESCRIPTION OF THE DRAWINGS

FIG. 1 is a schematic structure diagram of a cutting system of a core-making system of the present invention.

FIG. 2 is a schematic diagram of a control principle of a computer control system of the present invention.

FIG. 3 is an implementation flow diagram of the computer control system of the present invention.

FIG. 4 is an image acquisition completion interface diagram of a control system of the present invention.

FIG. 5 is an interface diagram of automation division of a coring position after image processing of the control system of the present invention.

FIG. 6 is a calculation flow process involved in a specific implementation.

In the figures, 1 denotes a cutter of a numerical control cutting machine; 2 denotes an upper rotation turntable; 3 denotes a lower rotation turntable; 4 denotes an operating handle; 5 denotes a linear array CCDa; 6 denotes a linear array CCDb; 7 denotes a recipient wax block rack; 8 denotes a worktable of the numerical control cutting machine; 9 denotes an X-axis translation worktable; 10 denotes a Y-axis translation worktable; 11 denotes a Z-axis translation worktable; 12 denotes an X-axis sliding device; 13 denotes a Y-axis sliding device; 14 denotes an ascending and descending stud; 15 denotes an X-axis stepping motor connecting position; 16 denotes a Y-axis stepping motor connecting position; 17 denotes a Z-axis stepping motor connecting position; 18 denotes angle scales of the lower rotation turntable; 19 denotes angle scales of the upper rotation turntable; and 20 denotes a freezing table.

### DETAILED DESCRIPTION OF THE EMBODIMENTS

Description paragraphs for preferred implementations of the present invention are entered here.

To make technical solutions of the present invention clearer, a tissue chip core-making system and method based on CCD positioning of the present invention is described in detail below with reference to the accompanying drawings. It should be understood that, the embodiments described herein are merely used for explaining the present invention, and are not intended to limit the protection scope of the claims of the present invention.

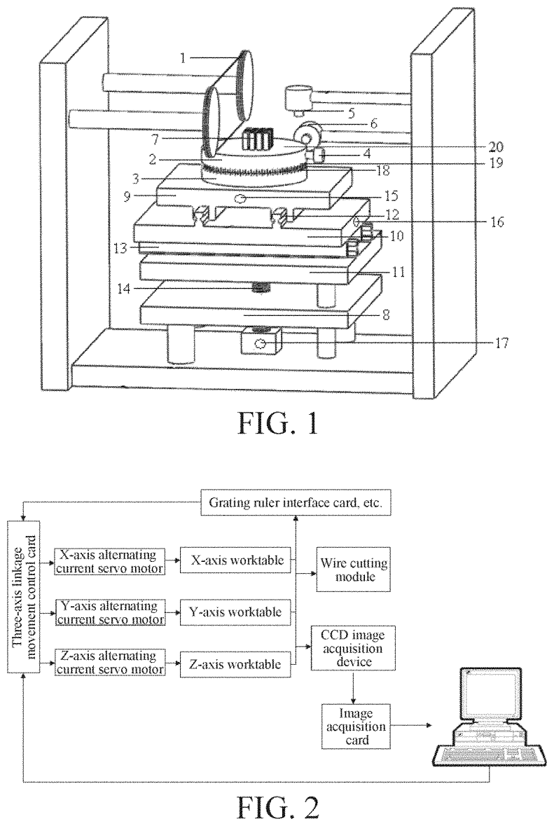

Main components of a core-making system involved in the present invention include a cutting system and a computer control system. The cutting system is shown as FIG. 1. The cutting system includes a numerical control cutting machine, XYZ-axis translation worktables, a 360° rotation turntable, a recipient wax block rack 7, a freezing table 20 and an image recognition and positioning module. The numerical control cutting machine includes a cutting machine worktable 8 and a cutter 1. The XYZ-axis translation worktables are disposed on the cutting machine worktable. The 360° rotation turntable is disposed on the XYZ-axis translation worktables. The 360° rotation turntable is of a cylindrical structure. The freezing table is disposed on the 360° rotation turntable. The freezing table is of a round plate-shaped structure, is of the same size as a cross section of the 360° rotation turntable, and is fixed on the 360° rotation turntable through screws, so that dismounting is convenient. The cutter is disposed right above the freezing table. The XYZ-axis translation worktables are sequentially an X-axis translation worktable 9, a Y-axis translation worktable 10 and a Z-axis translation worktable 11 from top to bottom. An X-axis sliding device 12 is disposed between the X-axis translation worktable and the Y-axis translation worktable. A Y-axis sliding device 13 is disposed between the Y-axis translation worktable and the Z-axis translation worktable. An ascending and descending stud 14 is disposed at the lower part of the Z-axis translation worktable. The X-axis sliding device mainly controls the X-axis translation worktable to translate in an X-axis direction. The Y-axis sliding device mainly controls the Y-axis translation worktable and the X-axis translation worktable to translate in a Y-axis direction. The X-axis sliding device or the Y-axis sliding device is a set combination of a sliding table, a guide rail and a ball screw. The sliding table of the X-axis sliding device is disposed at the bottom of the X-axis translation worktable. The guide rail of the X-axis sliding device is disposed on the top of the Y-axis translation worktable. The ball screw is disposed between the sliding table and the guide rail of the X-axis sliding device. The sliding table of the Y-axis sliding device is disposed at the bottom of the Z-axis translation worktable. The guide rail of the Y-axis sliding device is disposed on the top of the Z-axis translation worktable. The ball screw is disposed between the sliding table and the guide rail of the Y-axis sliding device. The ascending and descending stud mainly controls the whole XYZ-axis translation worktables to move in a direction perpendicular to the Z axis. An X-axis stepping motor is disposed at a side surface of the X-axis translation worktable (the X-axis stepping motor is not shown in the drawings, and its connecting position is denoted by 15 in FIG. 1). A corresponding Y-axis stepping motor is disposed at a side surface of the Y-axis translation worktable (the X-axis stepping motor is not shown in the drawings, and its connecting position is denoted by 16 in FIG. 1). A Z-axis stepping motor is disposed at the bottom of the Z-axis translation worktable (the X-axis stepping motor is not shown in the drawings, and its connecting position is denoted by 17 in FIG. 1). The X-axis stepping motor controls the X-axis sliding device to drive the X-axis translation worktable to leftwards and rightwards translate along the X axis. The Y-axis stepping motor controls the Y-axis sliding device to drive the Y-axis translation worktable and the X-axis translation worktable to forwards and backwards translate along the Y axis. The Z-axis stepping motor controls the ascending and descending stud to drive the XYZ-axis translation worktables to upwards and downwards move in the Z-axis direction. Through the X-axis stepping motor, the Y-axis stepping motor and the Z-axis stepping motor, the XYZ-axis translation worktables can be controlled to be in any position in a three-dimensional space. Travel ranges of the X axis, the Y axis and the Z axis are all from −100 mm to 100 mm. The X-axis stepping motor, the Y-axis stepping motor and the Z-axis stepping motor are connected to the computer control system through a three-axis linkage control card. Grating rulers and encoders are respectively disposed on the X-axis translation worktable and the Y-axis translation worktable of the XYZ-axis translation worktables, and a grating ruler and an encoder are disposed on a stud of the Z-axis translation worktable. Movement of the XYZ-axis translation worktables can be precisely controlled. The 360° rotation turntable is fixed on the XYZ-axis translation worktables. The 360° rotation turntable includes an upper rotation turntable 2 and a lower rotation turntable 3. The lower rotation turntable is fixed on the X-axis translation worktable through screws. The upper rotation turntable and the lower rotation turntable are movably connected. The upper rotation turntable can rotate freely within a 360° angle relative to the lower rotation turntable. Angle scales 19 and 18 are respectively disposed on side surfaces of the upper rotation turntable and the lower rotation turntable, and are configured to indicate a relative rotation angle of the upper rotation turntable and the lower rotation turntable. An operating handle is also disposed on the side surface of the upper rotation turntable, and is configured to realize rotation and fixation operation of the upper rotation turntable. The recipient wax block rack is put on the freezing table. A plurality of recipient wax blocks can be put on the recipient wax block rack. Feature images convenient for a CCD module to recognize are disposed on the periphery of a framework of the recipient wax block rack. When the 360° rotation turntable is not used, the 360° rotation turntable is dismounted. The recipient wax block rack can also be directly put on the XYZ-axis translation worktables. The image recognition and positioning module includes a linear array CCDa 5 and a linear array CCDb 6. The linear array CCDa 5 is disposed above the freezing table, and is configured to recognize and acquire patterns of an X-Y plane. The linear array CCDb 6 is disposed at the lateral part of the 360° rotation turntable, and is configured to recognize and acquire patterns in a Z-axis direction. The linear array CCDa 5 and the linear array CCDb 6 are both connected with the computer control system. The computer control system is connected with the CCD module through a Matrox Solis ECL/XCL-B image acquisition card, and is configured to realize control and data storage.

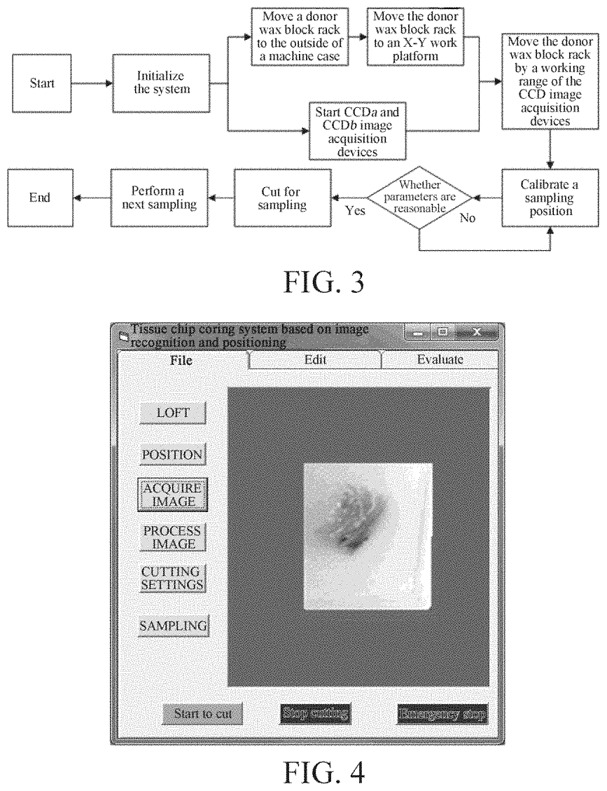

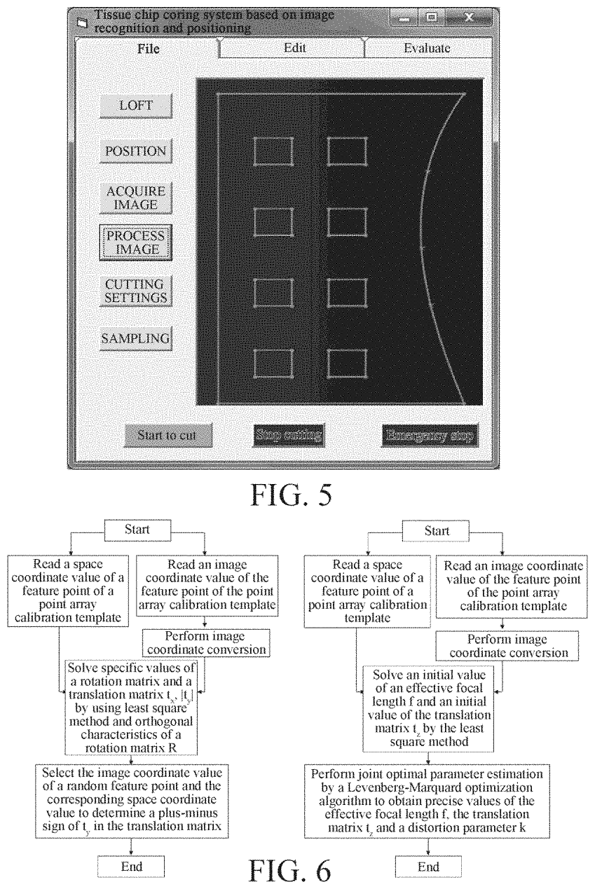

According to a core-making method of a tissue chip core-making system based on CCD positioning, a flow process implemented by a computer control system (a built-in software system of a camera manufacturer→image acquisition and analysis software ProgRes CapturePro of Germany Jena Company) is shown in FIG. 3, and includes the following detail steps:

1) A sample wax block is precooled to 0 to 4° C. A control system interface is entered. A LOFT button is clicked. A donor wax block rack moves to the outer side through a Y-axis translation worktable. The sample wax block is fixed on the donor wax block rack. The donor wax block rack enters a work region through the Y-axis translation worktable.

2) A POSITION button is clicked in computer software. A linear array image recognizer a is started. Specific images are respectively disposed at each of four corners of an outer frame of the wax block rack for putting a recipient wax block and are configured to be recognized through the linear array image recognizer a. At the same time, the specific images are used as an image acquisition boundary, and an image acquisition speed is accelerated. After the linear array image recognizer a recognizes the specific images on the four corners of the donor wax block rack, the position information of the specific images are automatically stored in a computer.

3) The position of the donor wax block is determined. An ACQUIRE IMAGE button is clicked. Through the movement of the XYZ-axis translation worktables in an X-Y plane, the linear array image recognizer a performs image acquisition on the recipient wax block in the X-Y plane. A linear array image recognizer b acquires lateral side images of the recipient wax block through the movement of a Z-axis ascending and descending worktable. After the image acquisition by the linear array image recognizer a and the linear array image recognizer b is completed, according to internal and external parameters calculated by a Tsia algorithm, respective space three-dimensional coordinate values correspondingly in a coordinate system are calculated by a CCD camera imaging mathematical model. A calculation process is shown in FIG. 6 below. A three-dimensional image of the recipient wax block is obtained.

4) An operation interface displays acquired images. By calculating grayscale of the acquired images, or manually performing region selection for imaging, boundary features of tissue samples in the recipient wax block are extracted. A coring control system will automatically calculate a relative position of the boundary region of the tissue samples and specific icons on the donor wax block rack.

5) An operator inputs the quantity of tissue cores to be cut and the cross-sectional size of the tissue cores into the operation interface. The coring control system can automatically divide an automatically extracted sample tissue region. According to a thickness of the sample tissues obtained by a linear array image recognizer b9, a cutting thickness of the tissue cores is set to be a little greater than the thickness of the sample tissues of visual recognition. If no value is input, a system default cross section area of the size of the cut tissue cores is 4 mm², and the thickness is 0.5 mm.

6) Cutting position checking is performed by manually controlling a cutting machine 1. A cutting wire is moved to any one point on a boundary of the wax block. The computer automatically stores coordinate information of the cutting line. After the checking is completed, a wire traveling track is set according to the divided coring region. A wire traveling speed of the cutting wire is set according to the features of the sample tissues (a system default value is 0.5 m/s).

7) A START TO CUT button on the operation interface is clicked. The donor wax block moves forward, backward, leftward and rightward on an X-Y translation work platform through an X-axis alternating current servo electric motor and a Y-axis alternating current servo electric motor, so that the recipient wax block is in a work platform of a cutting module. The X-Y translation work platform realizes cutting by controlling the Z-axis ascending and descending worktable to move upward and downward by an elevator.

8) After coring is completed, each of the obtained tissue cores is subjected to visual recognition to obtain the feature value thereof. The coring system automatically stores feature value information of the tissue core. The operator simultaneously adds other corresponding information of the sample tissues.

9) After the information recognition of the tissue cores is completed, the donor wax block rack returns to an initial position before cutting. A SAMPLING button is clicked. The recipient wax block rack slides to the outer side of the Y-axis translation worktable. The sample can be taken out through a mechanical hand or manually taken out. Then, a LOFT button is clicked. The recipient wax block returns to the work platform. The operation is completed.

What is claimed is:

1. A tissue chip core-making system based on image recognition and positioning, comprising:
a cutting system and a computer control system, wherein
the cutting system comprises a numerical control cutting machine, a plurality of XYZ-axis translation worktables, a 360° rotation turntable, a freezing table, a recipient wax block rack and an image recognition and positioning module;
the numerical control cutting machine comprises a cutting machine worktable and a cutter, the plurality of XYZ-axis translation worktables are disposed on the cutting machine worktable, the recipient wax block rack is disposed on the plurality of XYZ-axis translation worktables, the 360° rotation turntable is disposed on the plurality of XYZ-axis translation worktables, the freezing table is disposed on the 360° rotation turntable, the recipient wax block rack is disposed on the freezing table, and the cutter is disposed above the freezing table; and
the image recognition and positioning module comprises a linear array CCDa and a linear array CCDb, the linear array CCDa is disposed above the freezing table, and the linear array CCDa is configured to recognize and acquire a plurality of patterns of an X-Y plane, the linear array CCDb is disposed at a lateral part of the 360° rotation turntable, and the linear array CCDb is configured to recognize and acquire a plurality of patterns in a Z-axis direction, and the linear array CCDa and the linear array CCDb are both connected with to the computer control system.

2. The tissue chip core-making system according to claim 1, wherein the numerical control cutting machine is a numerical control diamond wire cutting machine or a numerical control optical fiber laser cutting machine.

3. The tissue chip core-making system according to claim 1, wherein the plurality of XYZ-axis translation worktables are sequentially an X-axis translation worktable, a Y-axis translation worktable and a Z-axis translation worktable from top to bottom.

4. The tissue chip core-making system according to claim 3, wherein
an X-axis sliding device is disposed between the X-axis translation worktable and the Y-axis translation worktable, a Y-axis sliding device is disposed between the Y-axis translation worktable and the Z-axis translation worktable, and an ascending and descending stud is disposed at a lower part of the Z-axis translation worktable;
an X-axis stepping motor is disposed at a side surface of the X-axis translation worktable, a Y-axis stepping motor is disposed at a side surface of the Y-axis translation worktable, and a Z-axis stepping motor is disposed at a bottom of the Z-axis translation worktable;
the X-axis stepping motor and the Y-axis stepping motor respectively control the X-axis sliding device and the Y-axis sliding device to drive the X-axis translation worktable and the Y-axis translation worktable to translate at a plurality of angles in the X-Y plane; and
the Z-axis stepping motor drives the Z-axis translation worktable to move upward and downward in the Z-axis direction by controlling the ascending and descending stud.

5. The tissue chip core-making system according to claim 4, wherein
the plurality of XYZ-axis translation worktables have a plurality of travel ranges of −100 mm to 100 mm in an X axis, a Y axis and a Z axis.

6. The tissue chip core-making system according to claim 4, wherein
the X-axis sliding device or the Y-axis sliding device is composed of a sliding table, a guide rail and a ball screw;
the sliding table of the X-axis sliding device is disposed at a bottom of the X-axis translation worktable, the guide rail of the X-axis sliding device is disposed on a top of the Y-axis translation worktable, and the ball screw is disposed between the sliding table and the guide rail of the X-axis sliding device; and
the sliding table of the Y-axis sliding device is disposed at the bottom of the Z-axis translation worktable, the guide rail of the Y-axis sliding device is disposed on a top of the Z-axis translation worktable, and the ball screw is disposed between the sliding table and the guide rail of the Y-axis sliding device.

7. The tissue chip core-making system according to claim 6, wherein a plurality of grating rulers and a plurality of encoders are respectively disposed on the sliding table of the X-axis translation worktable and the sliding table of the Y-axis translation worktable.

8. The tissue chip core-making system according to claim 4, wherein a grating ruler and an encoder are disposed on the ascending and descending stud of the Z-axis translation worktable.

9. The tissue chip core-making system according to claim 1, wherein the freezing table is of a round plate-shaped structure, a radius size is identical to a radius size of a cross section of the 360° rotation turntable, and the freezing table is fixed onto the 360° rotation turntable through a plurality of screws.

10. The tissue chip core-making system based on according to claim 1, wherein the 360° rotation turntable comprises an upper rotation turntable and a lower rotation turntable, the lower rotation turntable is fixed on the plurality of XYZ-axis translation worktables, the upper rotation turntable and the lower rotation turntable are movably connected, and the upper rotation turntable is configured to rotate freely within a 360° angle relative to the lower rotation turntable.

11. The tissue chip core-making system according to claim 10, wherein the 360° rotation turntable is respectively provided with a plurality of angle scales on a side wall of the upper rotation turntable and a side wall of the lower rotation turntable, an operating handle for controlling a rotation and a fixation of the upper rotation turntable is disposed on the side wall of the upper rotation turntable, and the lower rotation turntable is fixed on the plurality of XYZ-axis translation worktables through a plurality of screws.

12. The tissue chip core-making system according to claim 1, wherein a plurality of feature images for the image recognition and positioning module to recognize and position are respectively disposed at each of four corners of an outer frame of the recipient wax block rack for putting a recipient wax block.

13. The tissue chip core-making system according to claim 1, wherein the computer control system controls a movement of the plurality of XYZ-axis translation worktables, controls the image recognition and positioning module to perform an information acquisition and processing, and controls a cutting position checking of the numerical control cutting machine.

14. The tissue chip core-making system according to claim 13, wherein the computer control system is connected to each alternating current servo motor and a grating ruler of the plurality of XYZ-axis translation worktables through a three-axis linkage control card, and the computer control system is connected to the image recognition and positioning module through a Matrox Solis ECL/XCL-B image acquisition card.

15. A core-making method based on the tissue chip core-making system according to claim 1, comprising the following steps:
(1) fixing a recipient wax block on the recipient wax block rack, driving the plurality of XYZ-axis translation worktables to move by using the computer control system until a plurality of feature images on the recipient wax block rack are recognized by the image recognition and positioning module, and storing a position of the plurality of feature images as an original point by a computer;
(2) performing an image acquisition and information processing on the recipient wax block through the image recognition and positioning module to obtain a three-dimensional image of the recipient wax block;
(3) processing the three-dimensional image of the recipient wax block, and after a sample tissue region and a thickness of a plurality of sample tissues in the recipient wax block are obtained, setting a region available for core-making; and
(4) controlling the numerical control cutting machine through the computer control system to perform a cutting calibration, then, setting a plurality of cutting parameters, and cutting the recipient wax block to obtain a wax core.

16. The core-making method according to claim 15, wherein
the wax core obtained in the step (4) is subjected to visual recognition to obtain a feature value, a database is built, and feature value information of a tissue core and other information of the plurality of sample tissues are stored for subsequent use and query.

17. The core-making method according to claim 15, wherein the numerical control cutting machine is a numerical control diamond wire cutting machine or a numerical control optical fiber laser cutting machine.

18. The core-making method according to claim 15, wherein the plurality of XYZ-axis translation worktables are sequentially an X-axis translation worktable, a Y-axis translation worktable and a Z-axis translation worktable from top to bottom.

19. The core-making method based on the tissue chip core-making system according to claim 18, wherein
an X-axis sliding device is disposed between the X-axis translation worktable and the Y-axis translation worktable, a Y-axis sliding device is disposed between the Y-axis translation worktable and the Z-axis translation worktable, and an ascending and descending stud is disposed at a lower part of the Z-axis translation worktable;
an X-axis stepping motor is disposed at a side surface of the X-axis translation worktable, a Y-axis stepping motor is disposed at a side surface of the Y-axis translation worktable, and a Z-axis stepping motor is disposed at a bottom of the Z-axis translation worktable;
the X-axis stepping motor and the Y-axis stepping motor respectively control the X-axis sliding device and the Y-axis sliding device to drive the X-axis translation worktable and the Y-axis translation worktable to translate at a plurality of angles in the X-Y plane; and
the Z-axis stepping motor drives the Z-axis translation worktable to move upward and downward in the Z-axis direction by controlling the ascending and descending stud.

20. The core-making method according to claim 19, wherein
the plurality of XYZ-axis translation worktables have a plurality of travel ranges of −100 mm to 100 mm in an X axis, a Y axis and a Z axis.
